(19) United States
(12) Patent Application Publication
(10) Pub. No.: US 2011/0110090 A1
(43) Pub. Date: May 12, 2011

(54) AN INTEGRATED MULTIPLE OUTPUT LUMINAIRE

(76) Inventor: Pavel Jurik, Postredni Becva (CZ)

(21) Appl. No.: 12/922,166

(22) PCT Filed: Mar. 11, 2009
(86) PCT No.: PCT/US09/36861

§ 371 Date: Jan. 14, 2011

Related U.S. Application Data
(60) Provisional application No. 61/068,915, filed on Mar. 11, 2008.
(60) Provisional application No. 61/106,965, filed on Oct. 20, 2008.

(30) Foreign Application Priority Data
Mar. 11, 2009 (US) 12402407

(51) Int. Cl. F21V 14/02; F21V 14/00

(52) U.S. Cl. 362/249.07; 362/227

(57) ABSTRACT

The present invention provides multiple projection systems within a single automated luminaire. The invention provides means for aligning the output of the multiple automated luminaries on a projection surface.

### RELATED APPLICATION(S)

This application is PCT filing related to U.S. Utility application Ser. No. 12/402,407 Filed on Mar. 11, 2009 and Provisional Application No. 61106965 filed on Oct. 20, 2008 and Provisional Patent Application Ser. No. 61/068,915 filed on Mar. 11, 2008.

### TECHNICAL FIELD OF THE INVENTION

The present invention generally relates to a light beam producing luminaire, specifically to a luminaire containing a plurality of light outputs which provide an integrated and pre-aligned output to provide improved functionality.

### BACKGROUND OF THE INVENTION

Luminaires used in the entertainment industry such as those commonly used in theatres, television studios, concerts, theme parks, night clubs and other venues can typically be broadly categorized into two main categories each with differing optical properties. The two categories are imaging and non-imaging. The imaging type (commonly known as spot lights) are designed to project a focused image of a pattern or stencil or are provided with a shutter system to allow sharp cut-off of the light to stop it impinging on a curtain or other areas of the stage. They are also often used to provide accent lighting to a well defined area of the scene. The non-imaging type typically produces a soft-edged diffuse beam often used for general illumination and to provide background lighting and color. The present invention is concerned with a luminaire which combines a plurality of light sources which may be of both the imaging and non-imaging types into a single luminaire.

It is known to overlay and combine the images from a plurality of imaging luminaires into a single image. These images may completely overlap and be aligned so as to create a brighter image or may be positioned adjacent to each other so as to provide a single larger image. However such devices utilize a plurality of separate luminaires and typically all such luminaires are of the imaging type. The well known DL2 image projector produced by High End Systems in Austin Tex. is a typical example of imaging luminiars used in this way. It is also well known to provide an overlay of the output from a plurality of luminaires where some of the luminaires are non imaging and some are imaging. The result may be an area illuminated to a background level and color by the non imaging luminaires with images from the imaging luminaires superimposed. However again the user needs to install and focus a number of different luminaires to achieve the desired result. These problems are compounded when automated moving luminaires are utilized.

There is a need for a luminaire which can provide a plurality of overlaid outputs which may be of both imaging and non imaging type and may be incorporated into a single automated luminaire.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an embodiment of the disclosure with a plurality of light outputs;

FIG. 2 illustrates an elevation front view of an exemplary embodiment of the disclosure showing a luminaire with a plurality of light outputs;

FIG. 3 illustrates an elevation front view of a further exemplary embodiment of the disclosure showing a luminaire with a plurality of light outputs;

FIG. 4 illustrates the output produced by the embodiment illustrated in FIG. 2;

FIG. 5 illustrates the output produced by the embodiment illustrated in FIG. 3;

FIG. 6 illustrates the embodiment illustrated in FIG. 1 where the output beams are substantially aligned;

FIG. 7 illustrates an embodiment of an alignment system;

### DETAILED DESCRIPTION OF THE INVENTION

Preferred embodiments of the present invention are illustrated in the FIGUREs, like numerals being used to refer to like and corresponding parts of the various drawings.

The present invention generally relates to a light beam producing luminaire, specifically to a luminaire containing a plurality of light outputs which provide an integrated and pre-aligned output to provide improved functionality.

In one embodiment the present invention utilizes two light output optical systems within a single luminaire where one optical system is an imaging system and the other optical system is a non-imaging system.

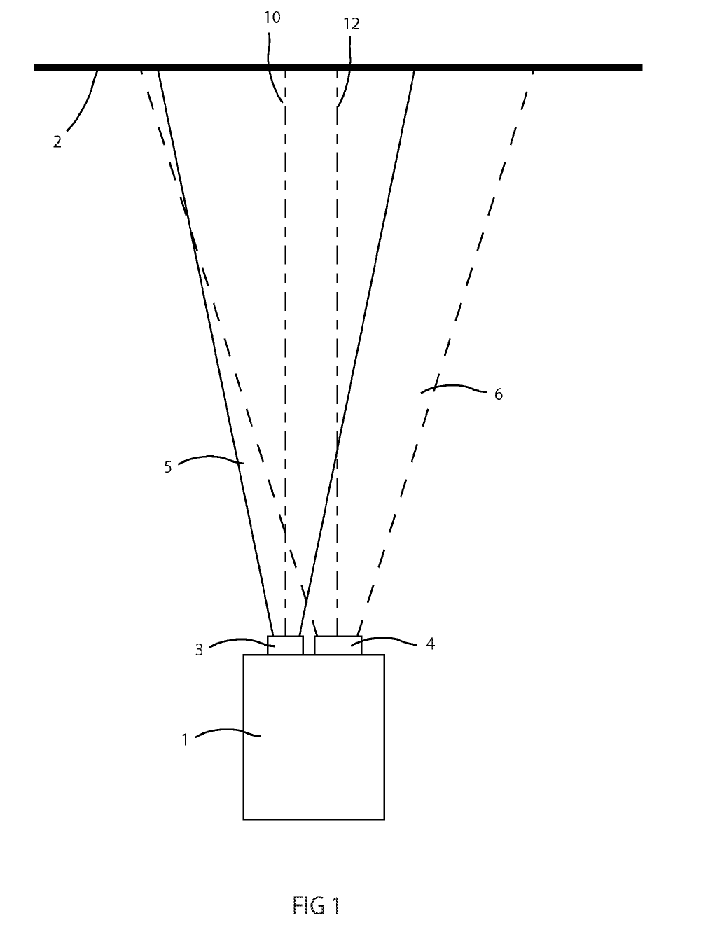

FIG. 1 illustrates an embodiment of the disclosure with a plurality of outputs each associated with a separate optical system. A luminaire 1 has a first output optical system 3 and a second output optical system 4. Output optical system 3 produces a light beam 5 which may impinge on a surface 2. Surface 2 may be a projection screen, a stage set, scenery or any other object. Output optical system 4 produces a light beam 6 which may impinge on the same surface 2. Light beams 5 and 6 may be directed so as to substantially overlap on the surface 2.

In a preferred embodiment of the luminaire system 1 the direction of the two beams can be aligned. Each beam 5 and 6 have a center optical axis 10 and 12 respectively. The adjustment means allow a user to adjust the direction of the beam so they align or substantially align on the projection surface 2 as described further below.

Output optical systems 3 and 4 may be the same or different. Both systems 3 and 4 could be image projection systems or one optical system may be an imaging system and the other may be a non-imaging system. Although only two imaging systems are here illustrated the disclosure is not so limited and any number or combinations of imaging systems may be utilized.

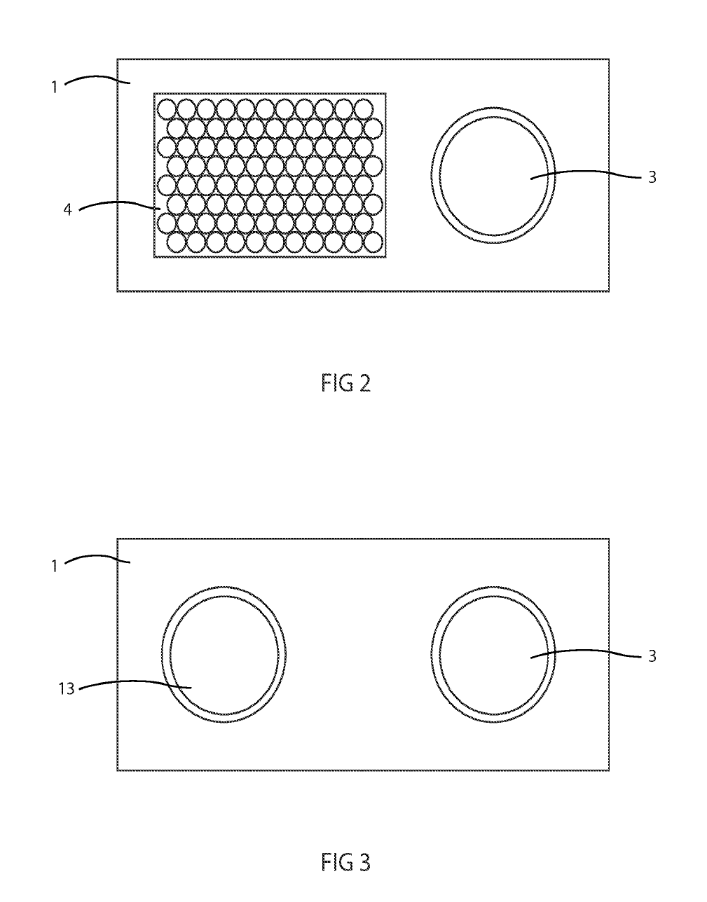

FIG. 2 illustrates an elevation front view of an exemplary embodiment of the luminaire 1 with a plurality of light outputs 3 & 4 where the imaging systems of the light outputs differ. Luminaire 1 has a first output optical system 3 where output optical system 3 is a projected image system and a second output optical system 4 where output optical system 4 is a non-image projection light system. Output optical system 3 may be a gobo or pattern based image projection system, a film based image projection system, a video based image projection system or other image projection system known in the art. Output optical system 4 may be a wash light comprising a plurality of LED illuminators or other non-imaging optical system as known in the art.

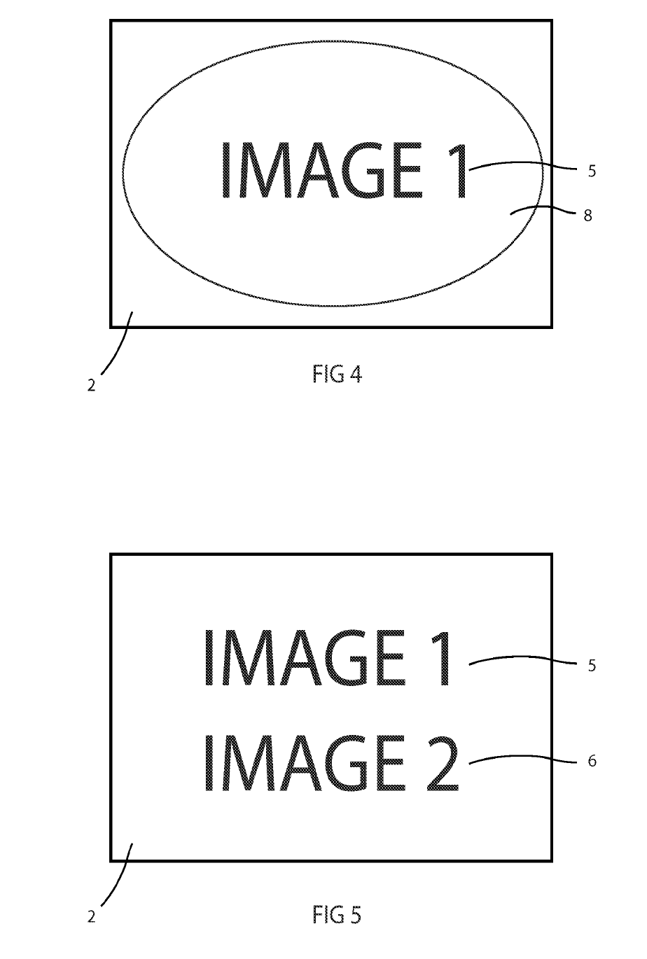

FIG. 4 illustrates the output produced by the embodiment illustrated in FIG. 2 where the output 5 from imaging optical system 3 and output 8 from non-imaging optical system 4 substantially overlap on surface 2. Output 8 is shown here as an oval for illustrative purposes only to indicate how the two outputs 5 and 8 overlap. In practice the beam 8 from non-imaging optical system 4 may be soft edged and diffuse providing general illumination on surface 2, it may also be round, elliptical or any other shape as known in the art. The shape and character of the non-imaging output 8 may be controlled by optical devices in the luminaire not covered by this disclosure such as beam focus, beam shaping, barn doors and other devices well known in the art.

FIG. 3 illustrates an elevation front view of a further exemplary embodiment of the disclosure showing a luminaire with a plurality of light outputs 3 & 13 where the imaging systems of the light outputs are the same. Luminaire 1 has a first output optical system 3 where output optical system 3 is an imaging system and a second output optical system 13 where output optical system 13 is also an imaging system. Output optical systems 3 and 13 may be gobo or pattern based image projection systems, film based image projection systems, video based image projection systems or other image projections system known in the art.

FIG. 5 illustrates the output produced by the embodiment illustrated in FIG. 3 where the output 5 from imaging optical system 3 and output 6 from a further imaging optical system 4b substantially overlap on surface 2. Outputs 5 and 6 are shown here as text images for illustrative purposes only to indicate how the two outputs 5 and 6 overlap. In practice the beams 5 and 6 from imaging optical systems 3 and 13 may comprise any image as known in the art. The shape and character of the imaging outputs 5 and 6 may be controlled by optical devices in the luminaire not covered by this disclosure such as beam focus, beam size or zoom, image selection, image color, image distortion, image manipulation and other devices well known in the art.

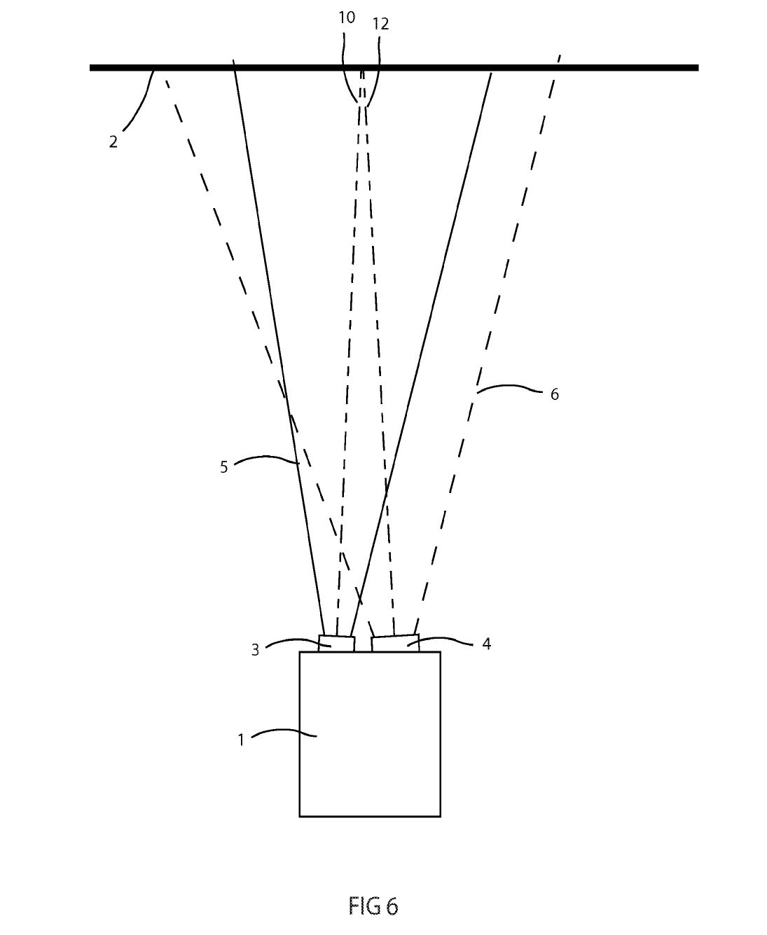

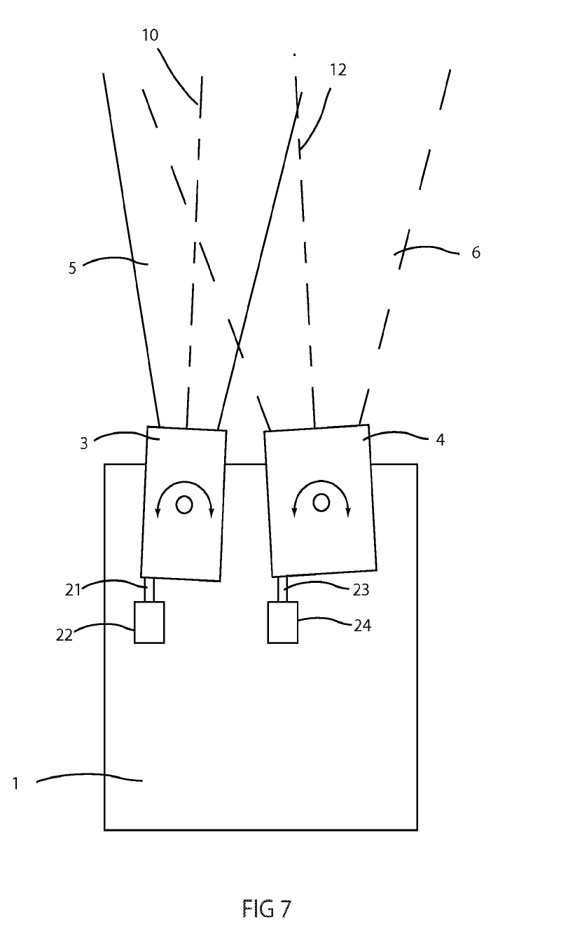

In a yet further embodiment and referring again to FIG. 1 the direction of output optical system 3 and the direction of output optical system 4 may be controlled such that their resultant light beams 5 and 6 substantially align on surface 2. FIG. 6 illustrates the system as shown in FIG. 1 where either or both of output optical system 3 and output optical system 4 are angled such that output beams 5 and 6 are substantially aligned and the center optical axes 10 and 12 are coincident on projection surface 2. Such alignment systems may be manual in some embodiments. In other embodiments the alignment system may be operated by a user via remote control. In yet other embodiments the alignment system may be automatic. The alignment system may include a sensor to measure the separation from luminaire 1 to surface 2 such as an optical range finder, acoustic range finder or other device known in the art. Alternatively the user may input data to luminaire 1 indicative of the separation from luminaire 1 to surface 2. The separation information however obtained may then be used by processes within luminaire 1 to control motors or other alignment altering devices so as to substantially align optical systems 3 and 4 on surface 2. FIG. 7 illustrates an embodiment of the invention incorporating alignment altering devices. Output optical system 3 of luminaire 1 is free to rotate about axis 25 and output optical system 4 is free to rotate about axis 26. Motor 22 is coupled through push rod 21 to output optical system 3 such that rotation of motor 22 causes linear motion of push rod 21 which, in turn, results in rotation of optical system 3 about axis 25. Similarly motor 24 is coupled through push rod 23 to output optical system 4 such that rotation of motor 24 causes linear motion of push rod 23 which, in turn, results in rotation of optical system 4 about axis 26. Rotation of motors 22 and 24 may be actioned locally or remotely through a communications link. Although a linear push rod is here illustrated to link motors 22 and 24 to optical systems 3 and 4 the invention is not so limited and other mechanisms including but not limited to gears, worm drives, lead screws and solenoids as well understood in the art may be used to translate the rotation of motors 22 and 24 to a rotation of optical systems 3 and 4 respectively. Additionally although two motors 22 and 24 are herein illustrated and both optical systems 3 and 4 are rotated further embodiments where only one of optical systems 3 or 4 rotates while the other remains static are envisaged.

In yet further embodiments luminaire 1 may be an automated luminaire where movement such as pan and tilt and optical functionality of the luminaire may be controlled remotely. Such automation utilizing control data from a lighting control desk via a standard data protocol such as DMX512, Artnet, RDM or ACN is well known in the art.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An automated luminaire comprising:
a first light beam source with a beam center axis;
a second light beam source with a beam center axis; and
where the first light beam source is a projector capable of projecting an image

2. The automated luminaire of claim 1 where the second light beam source is also a projector capable of projecting an image.

3. The automated luminaire of claim 1 which further comprises a beam axis modifier associated with either the first light beam source or the second light beam source which adjust the relative directional orientation of the center axis of the light beam sources.

4. The automated luminaire of claim 3 wherein the beam axis modifier is capable of being used to align the intersection of the beam center axis of the two light beam on a projection surface.

5. The automated luminaire of claim 3 in which the beam modifier is automated.

6. The automated luminaire of claim 5 in which the automated beam modifier can be controlled remotely by the user.

7. The automated luminaire of claim 1 wherein the projector light source is capable of projecting still images.

8. The automated luminaire of claim 1 wherein the projector light source is capable of projecting moving images in the form of video images or a rapidly progressing set of related still images.

8. The automated luminaire of claim 1 wherein the second light beam source is a wash light.

7. The automated luminaire of claim 8 where the wash light beam source is comprised of an array of LED light sources.
